(19) United States
(12) Patent Application Publication
(10) Pub. No.: US 2008/0162399 A1
(43) Pub. Date: Jul. 3, 2008

(54) Consumer marketing platform

(75) Inventors: Anthony L. Tam, Palo Alto, CA (US); Michael R. Abbott, Portola Valley, CA (US)

Correspondence Address: SCHWEGMAN, LUNDBERG & WOESSNER, P.A., P.O. BOX 2938, MINNEAPOLIS, MN, 55402, US

(73) Assignee: Think Passenger, Inc.

(21) Appl. No.: 11/649,080

(22) Filed: Dec. 31, 2006

(51) Int. Cl. G06N 5/00

(52) U.S. Cl. 706/59

(57) ABSTRACT

In some embodiments, a system and method for consumer marketing is illustrated. A system is illustrated that includes a receiver residing on a server to receive a rules set, a generator residing on the server to generate a rules model, a transmitter residing on the server to transmit a solicitation of data from a customer regarding good and services, and a second generator to create an updated rules model using an Artificial Intelligence (AI) algorithm, or some combination of AI algorithms. In some embodiments, a method is illustrated as including receiving a rules set, generating a rules model, soliciting data from a customer regarding good and services, and creating an updated rules model using an AI algorithm. Further, the method may include soliciting data using a communication process the process selected from a group of processes consisting of discussion boards, email, real-time chat, and a Short Message Service (SMS) message.

### TECHNICAL FIELD

The present application relates generally to the technical field of data mining applications and, in one specific example, the use of data mining to extract marketing data.

### BACKGROUND

Social networks are networks composed of individuals with shared values and interests. Some of these interested may be in certain hobbies, vocations, or good and services. For example, a club comprised of individuals who have an interest in HUMMERS™ or other vehicles could be thought of as a social network. And again, a network of individuals with an interest in certain collectibles could be a social network. Often times these individuals communicate with their own language and language structure.

### BRIEF DESCRIPTION OF THE DRAWINGS

Some embodiments are illustrated by way of example and not limitation in the figures of the accompanying drawings in which:

FIG. 1 is a block diagram illustrating an example system.

FIG. 2 is a block diagram of the various example sub modules that make up the qualification module.

FIG. 3 is a system diagram describing an example system to generate a rules set.

FIG. 4 is a system diagram describing an example system to elicit information from a customer.

FIG. 5 provides two example Graphical User Interfaces (GUIs) that are use to illustrate a User Interface (UI).

FIG. 6 is a flowchart depicting an example method used to implement a data integration layer.

FIG. 7 is a flowchart depicting an example method to implement the data normalization layer.

FIG. 8 is a flowchart depicting an example method used to implement a rules engine.

FIG. 9 is a flowchart depicting an example method used to implement an implicit rule module.

FIG. 10 is a flowchart depicting an example method implementing an explicit rule module.

FIG. 11 is a flowchart illustrating an example method used to implement a model module.

FIG. 12 is a flowchart illustrating an example method used to implement an association engine.

FIG. 13 is a block diagram depicting various modules that make up the profiling module.

FIG. 14 is an illustration of a user interface to prompt users with questions.

FIG. 15 is a flowchart illustrating an example method used to implement a user data integration layer.

FIG. 16 is a flowchart describing an example method used to implement an attribute definition module.

FIG. 17 is a block diagram describing the various example modules that are used to make up a qualitative modelling module.

FIG. 18 is a system diagram describing a real time chat module.

FIG. 19 is a system diagram depicting an example system used to direct questions or interrogative statements to, for example, a customer as implement via a discussion board module.

FIG. 20 is a system diagram describing a system used to implement a Short Message Service (SMS) module.

FIG. 21 is a system diagram describing a system used to implement an email module.

FIG. 22 is a flow chart illustrating an example method used to implement structural analysis module.

FIG. 23 is a module that supports a semantics module.

FIG. 24 is a flowchart used to illustrate an example method to implement a rules module.

FIG. 25 is a flowchart illustrating an example method used to implement a models module.

FIG. 26 is a flowchart illustrating an example method used to implement a content analysis module.

FIG. 27 is a flowchart describing an example method to implement a statistics module.

FIG. 28 is a flowchart illustrating an example method used to implement a notification module.

FIG. 29 is flowchart illustrating an example method to implement a models module.

FIG. 30 is a block diagram describing various example modules used to implement the quantitative modelling module.

FIG. 31 is a flowchart used to illustrate an example method to implement a statistics module.

FIG. 32 is a flowchart depicting an example method used to implement a notification module.

FIG. 33 is a flowchart used to depict an example method to implement a model module.

FIG. 34 is a block diagram describing various modules used to make up an analytics or mining module.

FIG. 35 is a flowchart illustrating an example method used to implement a consumer intelligence layer or module.

FIG. 36 is a flow chart describing an example method used to implement a data mining module.

FIG. 37 is a flowchart illustrating an example method to implement an analytics module.

FIG. 38 is a flowchart used to illustrate an example method used to implement an update module.

FIG. 39 is an example Relational Data Schema (RDS) that may reside on, for example, a database.

FIG. 40 is an example social network diagram.

FIG. 41 is a block diagram describing certain customers and hub reactions to a particular good or service.

FIG. 42 is a block diagram depicting an example use of a word.

FIG. 43 is a block diagram describing an example use of a phrase.

FIG. 44 is a block diagram illustrating an example customer reaction.

FIG. 45 shows a diagrammatic representation of a machine in the example form of a computer system.

### DETAILED DESCRIPTION

In the following detailed description of the preferred embodiments, reference is made to the accompanying drawings that form a part hereof, and in which are shown by way of illustration specific embodiments in which the invention may be practiced. It is understood that other embodiments may be utilized and structural changes may be made without departing from the scope of the present invention.

The leading digit(s) of reference numbers appearing in the Figures generally corresponds to the Figure number in which that component is first introduced, such that the same reference number is used throughout to refer to an identical component which appears in multiple Figures. Signals and connections may be referred to by the same reference number or label, and the actual meaning will be clear from its use in the context of the description.

Data mining is used, for example, to engage in the extraction of nontrivial implicit, previously unknown and potentially useful information. Many times this data is derived from a large data set, and it processed using one of many types of Artificial Intelligence (AI) based algorithms. These algorithms may include the following types Bayesian Decision Theory algorithm, a Maximum Likelihood and Bayesian Estimation algorithm, an algorithm implementing a Nonparametric Technique, a Linear Discrimination function or algorithm, a Multilayer Neural Networks algorithm, a Stochastic Methods or algorithm, a Nonmetric method or algorithm, an Algorithm-Independent Machine Learning, and/or an Unsupervised Learning and Clustering.

These algorithms are often times implemented in combination with certain database applications that are able to process large amounts of data, and provide a multidimensional analysis of the data such that associations between certain pieces of data can be understood over a long period of time. One common application that provides for multidimensional analysis is an On Line Analytic Processing (OLAP) application. A characteristic of OLAP is the ability to aggregate data into a view and can then be observed by a user of an OLAP system. In some cases, one or more of the various AI algorithms may be used to generate a view.

In some embodiments, a system and method is illustrated that allows for the generation of question sets for potential customers of good as services. For example, in some cases, a rule set is provided as apart of an existing rules set, or a rules set is generated by a person such as a brand manager. Once this rules set is generated, it is used to generate a question set for a potential customer or a good or service. The customer may, for example, be provided this question set through on online user interface (e.g., a GUI), an SMS message, email or other suitable means of communicating a question set to a customer. These questions may be more or less detailed depending on, for example, where the customer has previously provided information. For example, initial information may include identifying information (e.g., photo ID, social security number and the like), whereas later information may include information relating to the preferred means be which the customer likes to communicate (e.g., SMS, email etc.), or more importantly specific questions regarding a good or service. A customer may be asked, for example, their opinion as to a good or service, and more to the point, asked specific details as to their thoughts, impressions and like regarding a good or service.

In some embodiments, responses are provided to this detailed question, response which is then analyzed for content and semantic structure so as to capture the meaning of certain words contained therein. In some cases certain slang terms are to attributed meaning by the context within which these slang terms appear. This attributed meaning is stored as a synonym that can then later by analyzed by, for example, a brand manager for future use in the creation of a rules set. In some example embodiments, a set of these synonymous may be generated using certain AI algorithms include the Stochastic Methods or class of algorithms and in particular simulated annealing, neural networks and genetic algorithms. Once implemented, these algorithms will use a feedback loop to automatically update the question set or sets for certain customers. Put another way, in cases where the word “Cool” means denotes a normative value such as “Good”, the word “Cool” will be used to ask a customer as to their impressions regarding a particular good or service (e.g., instead of asking “Is this a car that people would want to drive?”, one might be asked “Is this car cool?”).

### A Three-Tier Architecture

In some embodiments, one implementation may be as a distributed or non-distributed software application designed under a three-tier software architecture paradigm, whereby the various modules of computer code that make up the one implementation can be categorized as belonging to one or more of these tiers. A three-tier architecture is well known in the art. The first tier is an interface level that is relatively free of application processing. The second tier is a logic level that performs processing in the form of logical/mathematical manipulations (logical manipulations) of data inputted through the interface level, and communicates the results of these logical manipulations with the interface and/or backend or storage level. Some example embodiments may include these logical manipulations relating to certain business rules or tasks that govern the application as a whole. These logical manipulations, and associated business rules, are used to elicit specific information regarding a good or service from a customer, and to frame certain questions regarding a good or service. The third tier or storage level is a permanent storage medium or, in some example embodiments, may include non-permanent storage medium. One or more of these tiers may be collapsed into one another, resulting in a two-tier architecture or one-tier architecture. For example, the interface and logic levels may be consolidated, or the logic and storage level may be consolidated, as in the case of an application with an embedded database. This three-tier architecture may be implemented using one technology, or as will be discussed below, a variety of technologies. These technologies may include one or more object-oriented programming languages such as, for example, JAVA™, C++, DELPHI™, C#™, or the like. Additionally, structured programming languages such as, for example, C may also be used. Moreover, scripting languages such as, for example, Perl, Python, PHP, JavaScript or VBScript may also be used. This three-tier architecture, and the technologies through which it is implemented can be implemented in two or more computers organized in a server-client relationship, as is well known in the art, such that an interface level resides on a client computer, whereas a logic level resides on the application server (see below) and the storage level resides on a database server (see below). As will be discussed more fully below, in such a relationship these three tiers can be implemented as various software components that communicate via distributed programming protocols. Some example embodiments may include these three tiers being implemented in a peer-to-peer configuration, or some other suitable file exchange paradigm, such that all three tiers reside on one or more computers and each computer retrieves files and data from one another. Peer to peer configurations are well known in the art.

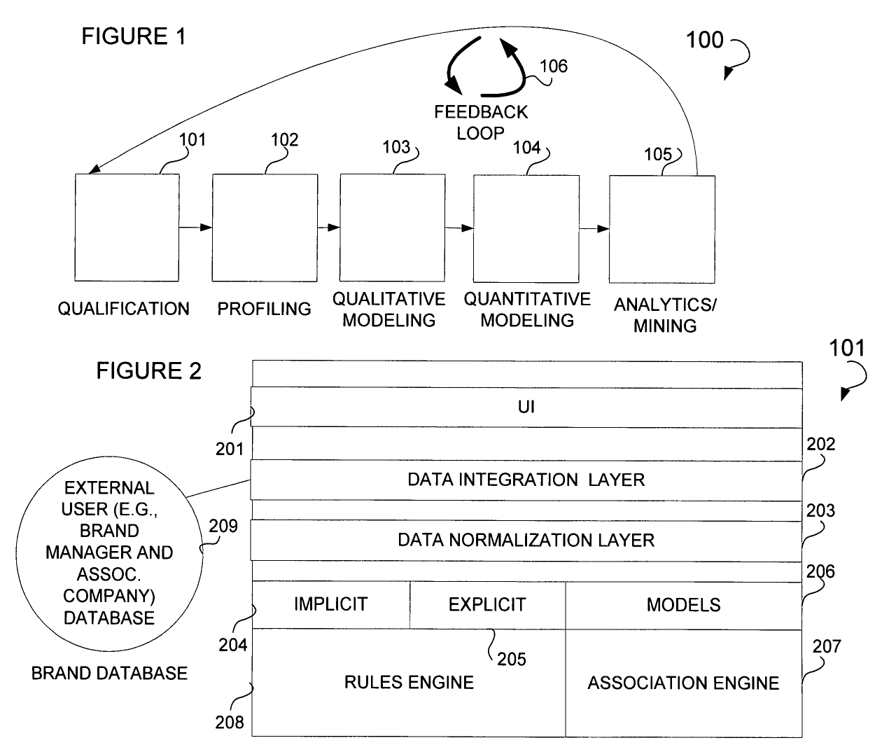

FIG. 1 is a block diagram illustrating an example system 100. Illustrated is a qualification module 101 operatively coupled to a profiling module 102 which, in turn, is operatively coupled to a qualitative modelling module 103. This module 103 is operatively coupled to a quantitative modelling module 104 which, in turn, is connected to an analytics or mining module 105. A feedback loop 106 exists between the analytics and mining module 105 and the qualification module 101. In some cases, this feedback loop 106 provides updated data for a question set, data derived from an AI algorithm. As will be discussed below, this feedback loop 106 allows for analysis of data and mining of data to occur at the module 105, and the results of this mining and analysis to be passed to the qualification module 101 for future use.

FIG. 2 is a block diagram of the various example sub modules that make up the qualification module 101. Illustrated is a UI 201 that is operatively coupled to a module 202 known as a data integration layer. This data integration layer 202 is operatively coupled to a data normalization layer 203 further this data normalization layer 203 provides normalized data to a rules engine 208 and an association engine 207. In some cases, the rules engine 208 is operatively coupled to a module 204 that uncovers implicit rules, and a module 205 that uncovers explicit rules. Further, a module 206 may be used to generate models utilizing the various rules, wherein these modules are directed towards certain social networks or groups. In some cases, in lieu of a UI 201 being used to provide a rule set, a database 209 may be utilized, wherein the database contains data form certain brands. The various functionalities associated with module 201 through 208, and database 209, will be more fully described below.

### An Interface Level

A further example embodiment may be implemented using a client-so architecture, and using a client-based application (e.g., a browser application or a programmatic client application). Some well-known client-based browser applications include NETSCAPE™, INTERNET EXPLORER™, MOZILLA FIREFOX™, OPERA™, or some other suitable browser application. Common to these browser applications is the ability to utilize a Hyper Text Transfer Protocol (HTTP) or Secured Hyper-Text Transfer Protocol (HTTPS) to get, upload (e.g., PUT) or delete web pages and interpret these web pages, which are written in a hyper-text mark-up language (HTML) and/or an Extensible-Mark-up Language (XML). HTTP and HTTPS are well known in the art, as are HTML and XML. HTTP and HTTPS may be used in conjunction with a Transmission Control Protocol/Internet Protocol (TCP/IP) as described in the Open Systems Interconnection (OSI) model, or the TCP protocol stack model, both of which are well known in the art. The practical purpose of the client-based browser application is to enable a user to interact with the application through the display of plain text, and/or interactive dynamic functionality in the form of buttons, text boxes, scroll down bars or other objects contained on one or more web pages constructed using the aforementioned HTML and/or XML.

Web pages may be static or dynamic in nature. Those that are static typically display text as one would see it on a printed, physical page. Dynamic web pages, however, are interactive and allow for a user to input data, query data, and/or modify data just to name a few of the functionalities associated with dynamic web pages. The dynamic nature of web pages is a product of the use of the other technologies in combination with HTML and/or XML.

Java Server Page (JSP™), or Active Server Pages (ASP™ or ASP.NET™) (collectively server pages) may be used to provide a user with dynamic web pages or content via their web browser. Additional technology in the form of an additional program (e.g., routine) written in another programming language is embedded into the HTML and/or XML code, allowing for web pages to become dynamic. Some of these additional technologies include, for example, embedded routines written in the Java programming language, the JavaScript™ language, or the VBScript programming language or some other suitable programming language. These embedded routines are used to execute the aforementioned HTTP, HTTPS requests (e.g., GET, PUT, and DELETE) for web pages. Various types of programming structures such as branches, loops and other types of logic structures are used in such routines. These routines may allow a user to log in and request content to upload or download. For example, a GUI is used and is implemented via a Java Servlet, Applet, or VBScript or C# form, or some other suitable programming language. As is discussed below, web pages containing GUIs are stored at the logic level, but executed at the interface level via a web browser. These server pages contain objects such as text boxes, buttons, scroll-down bars, or some other suitable dynamic interface object. These objects, and the routines governing them, allow a user to retrieve, input, or delete content, just to name few of the functions. For example, a brand manager or other user may be prompted with a GUI that enables them to generate rules set to create questions for a customer. And again, in some cases, a GUI for a customer may be implemented so as to allow the customer to answer certain questions relating to identifying information, or specific questions regarding a good or service.

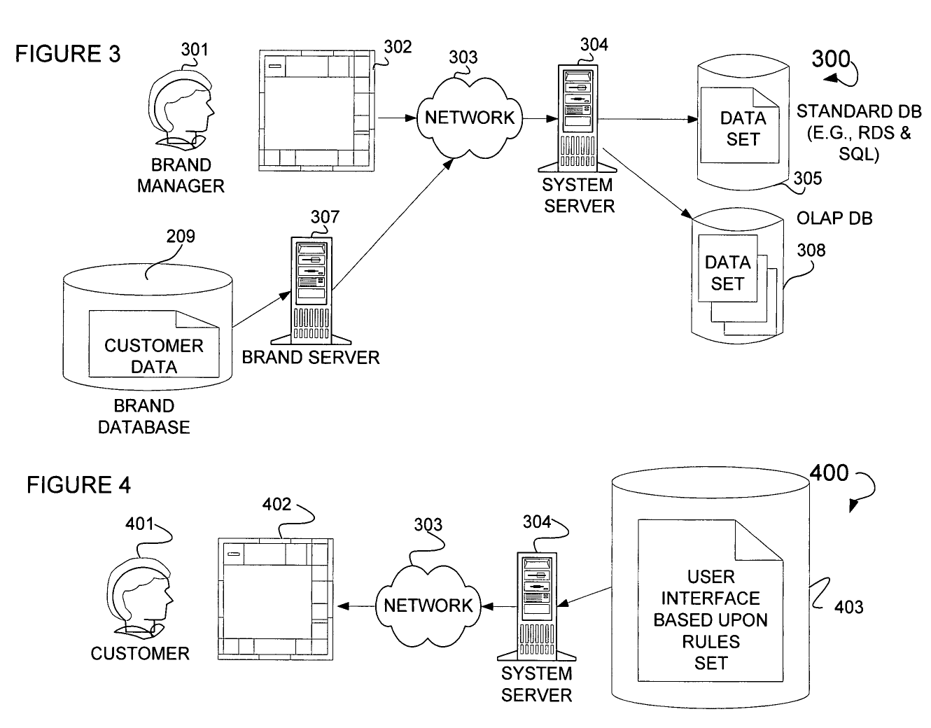

FIG. 3 is a system diagram describing an example system 300 to generate a rules set. Illustrated is a brand manager 301 who provides rules data via a GUI 302. A rule in this rules set may take the form of a question such as: “What are you favourite shoes for basket ball?”, or “Is the Ford Mustang a good car?”. Once this rules data is provided via the rules interface 302 it is passed along a network 303 to a system server 304. This network may be an internet, Local Area Network (LAN), Wide Area Network (WAN) or some other suitable network. This system server 304 then processes the rules provided by the brand manager 301 and stores these process rules into, for example, a database 305. In some embodiments, an OLAP database 308 may also be implemented to store a data set or rules set. In some cases, the database 209 will be operatively coupled to a server 307 which will be a brand server. This server 307 will be operatively coupled to a system server 304 via a network 303 so as to supply customer data from the database 209 to the system server 304. In some cases, this customer data will be a rules set. This system server may be an application server such as an Java Enterprise Edition Server (Java EE or J2EE) certified server using the Java OLAP Interface, a Microsoft SQL server running, for example, Microsoft Analysis Services or some other suitable application server.

FIG. 4 is a system diagram describing an example system 400 to elicit information from a customer. Illustrated is a customer 401 who via a user interface 402 observes certain questions or interrogative statements designed to a list of responses regarding goods or services from the customer 401. These questions that are presented via the user interface 401 are transmitted across a network 303 from a system server 304. This system server 304 is operatively coupled to a database 403 containing a rule set used to generate the questions that the customer 401 may be asked to answer. In some embodiments, this rule set is based upon the data set provided by the brand manager 301 whereas, in other embodiments, this rule set is based upon the customer data provided via the database 209 in brand server 307. In some cases, the rules set contained in the database 403 may be generated by a manufacturer of a good or service. For example, COCA-COLA™ Company could supply a rules set containing rule relating to customers of various COCA-COLA™ products such as COKE™, asking these customers questions such as “Is coke a good product?”.

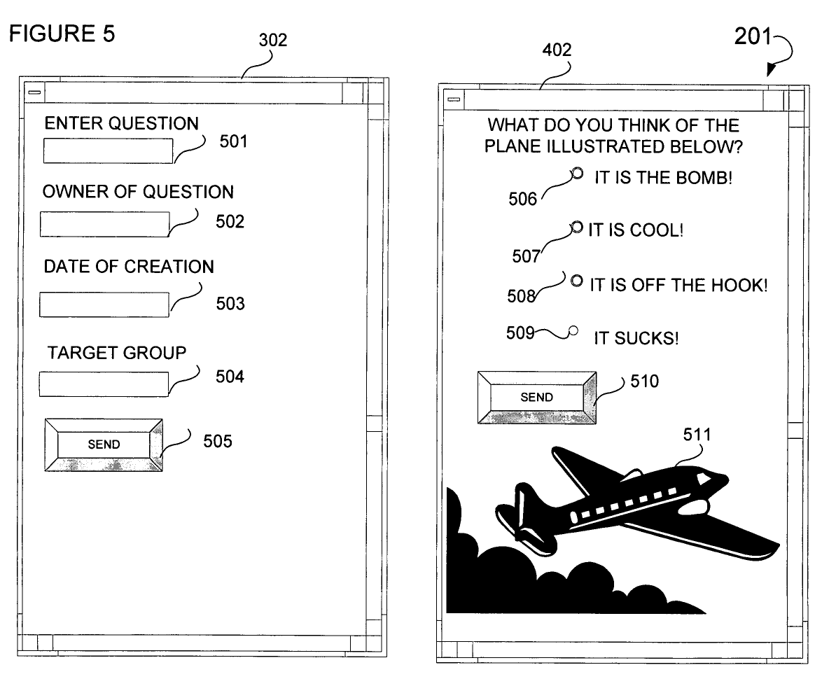

FIG. 5 provides two example GUIs that are use to illustrate UI 201. Illustrated is a rules interface 302 for brand manager 301 with a variety of screen objects or widgets including a text box 501 to enter a question to be provided to a customer such as customer 401. Additionally, a text box 502 is described that allows a brand manager to enter the identity of the individual who wrote the question. Next, a text box 503 allows a brand manager to date the creation of the question. Further, a text box 504 allows a brand manager to identify the group for which the question is intended. Moreover, once data is provided via the text boxes (e.g., Nos. 501-504), it can be sent via a button 505.

In addition to the rules interface 302, a user interface 402 is illustrated. Described is a user interface 402 with various radio buttons 506-509. These radio buttons allow a customer such ad customer 401 to select the phrase that most closely captures their feelings about a good or service, which in this case is a picture of an airplane 511. Once a customer selects a phrase (e.g., the plane “is the bomb!”, “it is cool!” or “it sucks!”) using one of the radio buttons, then the send button 510 is executed so as to select the phase and send it to the system server 304 to be recorded into a database.

### Logic Level

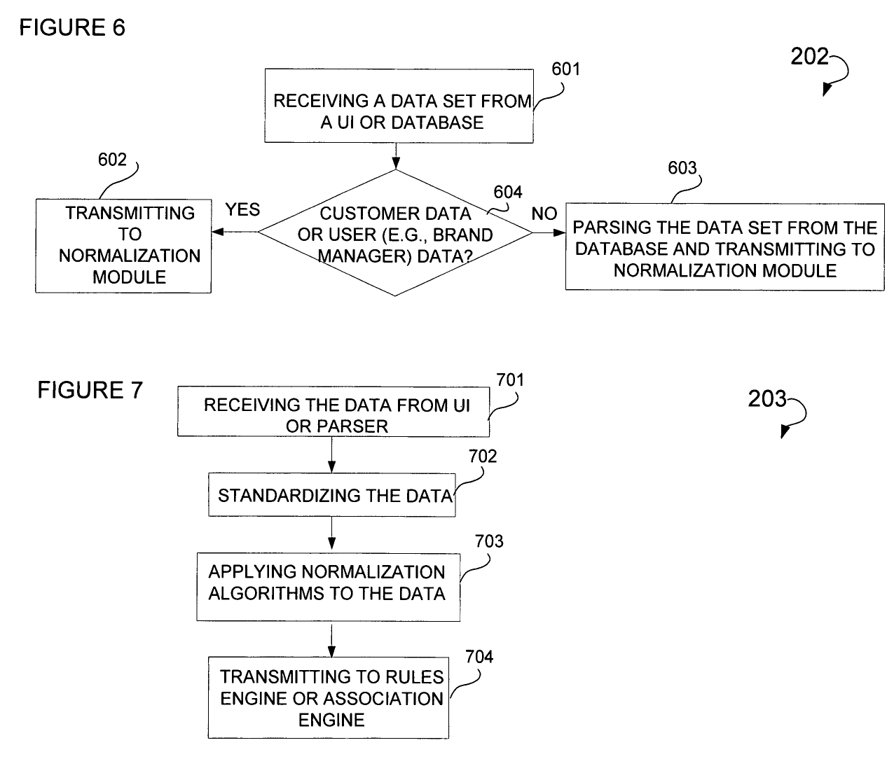

FIG. 6 is a flowchart depicting an example method used to implement a module 202. Illustrated is a module 601 that receives the data set from a UI or database such as database 403. In some embodiments, this UI is the user interface 302 whereas, in other cases, this database is the database 209. Once this data set is received, then a decisional module 604 is executed wherein if the decisional module 604 evaluates to true, then customer data has been provided to the module 202. Where customer data is provided to the module 202, then a module 602 is executed that transmits this customer data to a normalization module. If the decisional module 604 evaluates to false, then a module 603 is executed that parses the incoming data set from the database 209 and transmits this data to a normalization module.

FIG. 7 is a flowchart depicting an example method to implement the module 203. Illustrated is a module 701 that receives data from a UI, or from a parser. Once this data is received, a module 702 is executed that standardizes the data. Data standardization may be used in those cases where the incoming data from the database 209 is not in a form that can be easily utilized by the system server 304. Once data standardization occurs, then a module 703 is executed that applies a normalization algorithm to the data. In some cases, this normalization algorithm is used to address such types of data anomalies such as non-additive joins and other types of anomalies that decrease the efficiency of a database. These normalization algorithms may further normalize the data into a Boyce-Codd normalized form, or other suitable database normalization algorithm known in the art. Once data normalization takes place, a module 704 is executed that transmits this data to a rules engine or an association engine.

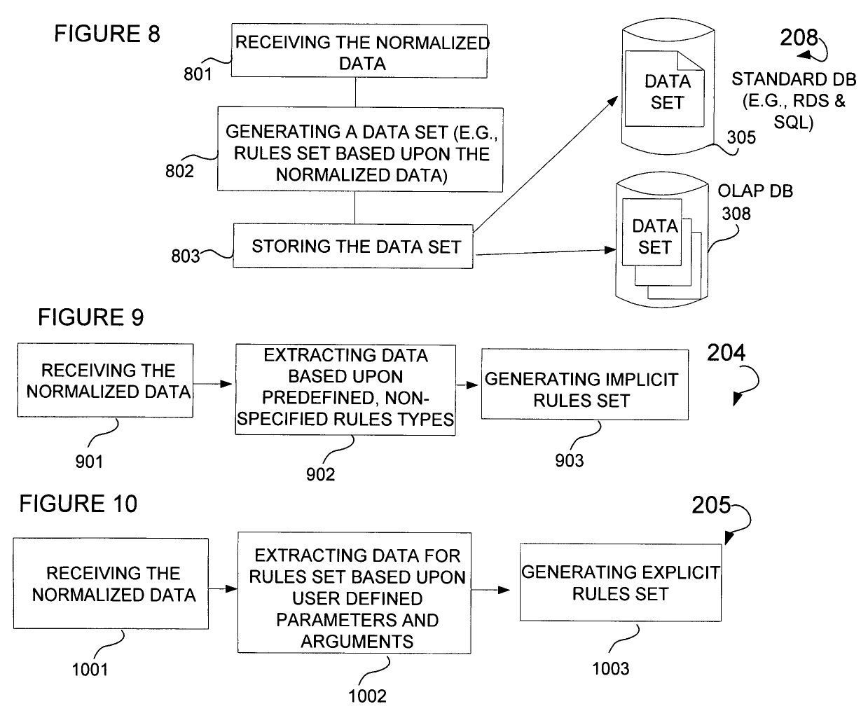

FIG. 8 is a flowchart depicting an example method used to implement module 208. Illustrated is a module 801 that receives normalized data. Once this normalized data is received, a module 802 is executed that generates a data set. This data set may be, for example, a rules data set based upon normalized data. After module 802 generates a data set, then a module 803 is implement that stores the data set. In some embodiments, this data set is stored to a database such as database 305 that implements, for example, a Relational Data Schema (RDS) and utilizes a structured query language. In still other embodiments, a database 308 is implemented that utilizes OLAP, and more to the point, a multidimensional database utilizing, for example, a hyper cube or a multidimensional cube. This OLAP database may also implement the Multidimensional Expression (MDX) query language in lieu of, or in addition to, a Structured Query Language (SQL). In some embodiments, the data aggregation standards (e.g., views or viewing sections) utilized for OLAP are implemented on the system server 304 by, for example, a brand manager 301, a system administrator, or some other suitable individual.

FIG. 9 is a flowchart depicting an example method used to implement an implicit rule module 204. Illustrated is a module 901 that receives normalized data. Where this normalized data is received, a module 902 is executed that extracts this data based upon certain predefined yet non-specified rule types. In some embodiments, these predefined yet non-specified rule types are defined by the system administrator or, for example, a brand manager 302. Once this data is extracted by module 902, a module 903 is implemented that generates what is referred to as an “implicit rule set”. This implicit rule set may be stored into the previously illustrated and described database 305 or database 308. An example of an implicit rule set may, for example, be certain types of example normalized data that are found commonly together. For example, if a data set provided by a customer 401 contains certain words that are commonly found in combination such as the word “red” and the word “HUMMER™” then it may be the case that a rule set could be generated implicitly wherein the word “red” and “HUMMER™” are used in combination with all queries directed towards the customer 401 that relate to automobiles.

FIG. 10 is a flowchart depicting an example method implementing an explicit rule module 205. Illustrated is a module 1001 that receives normalized data. Once this normalized data is received it is passed to a module 1002 wherein the data is extracted to form a rule set based upon certain predefined parameters and arguments. These predefined parameters and arguments are provided by a system administrator, a brand manager 301, or some other suitable person. Once this data is extracted a module 1003 is executed that generates what could be referred to as an explicit rule set. For example, the brand manager 301 utilizing the GUI 302 may generate an explicit rule set such as, for example, wherein such that the word “black” and “PORSCHE™” always occur together and that the combination of the words “black” and “PORSCHE™” should always provided to a customer 401 when asking them or directing a query to them regarding PORSCHE™ in general.

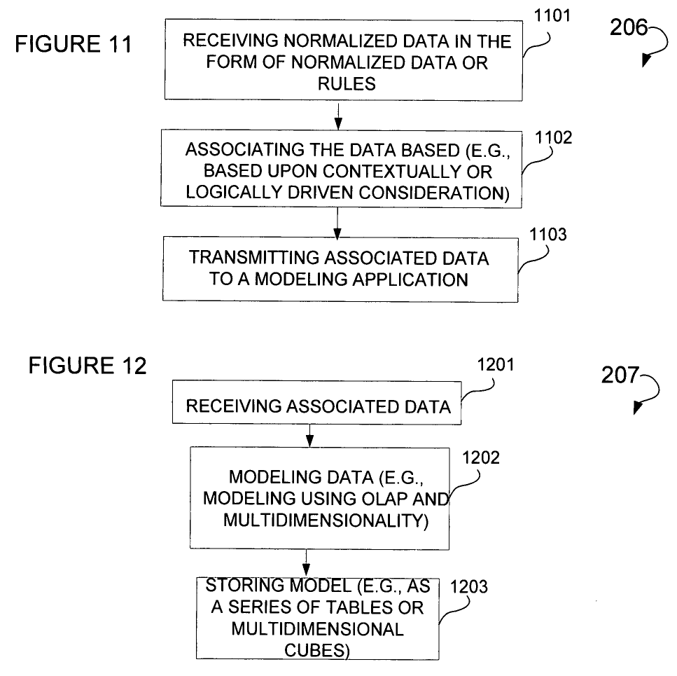

FIG. 11 is a flowchart illustrating an example method used to implement a model module 206. Illustrated is a module 1101 that receives normalized data in the form of a normalized data or rules. Once received, a module 1102 is executed that associates the data or rules. In some embodiments, this association occurs by way of some contextually driven or logically driven considerations. For example, where a particular customer 401 utilizes a particular word or phrase, this word or phrase will be associated with that customer in the database. Once module 1102 is executed, a module 1103 is executed that transmits the associated data to a modelling application.

FIG. 12 is a flowchart illustrating an example method used to implement an association engine 207. Illustrated is a module 1201 that receives associated data. Once this associated data is received, a module 1202 is executed that actually models the received associated data. Once modelled, this associated data is stored using a module 1203. In some embodiments, the modelled data is stored into the database 305 whereas, in other embodiments, it is stored into the database 308. In those instances where the model is stored into the database 308, this model may be stored into a multidimensional cube wherein various aspects of the module may be viewed together, or in combination with, other aspects over some period of time. For example, it may be possible, utilizing the multidimensional cube of the database 308, to view customer 401 may use particular words in combinations over a period of time. This use and combination may be seen as a trend over a period of time wherein the uses of certain words increases or decreases. For example, if a customer 401 utilizes the phrase “off the hook” this phrase can be understood in a historical sense over time in combination with certain types of other phrases or words. For example, the phrase “off the hook” can be seen in combination with the words PORSCHE™, HUMMER™ or some other good or service wherein the multidimensional cube allows, for example, a brand manager 301 to track and understand the amount of times that this phrase “off the hook” has been used. Additionally, this phrase “off the hook” can be understood not only with relationship to certain goods or services, but more to the point a variety of goods or services over an extended time. These goods and services to which the phrase relates may be represented graphically utilizing, for example, a GUI.

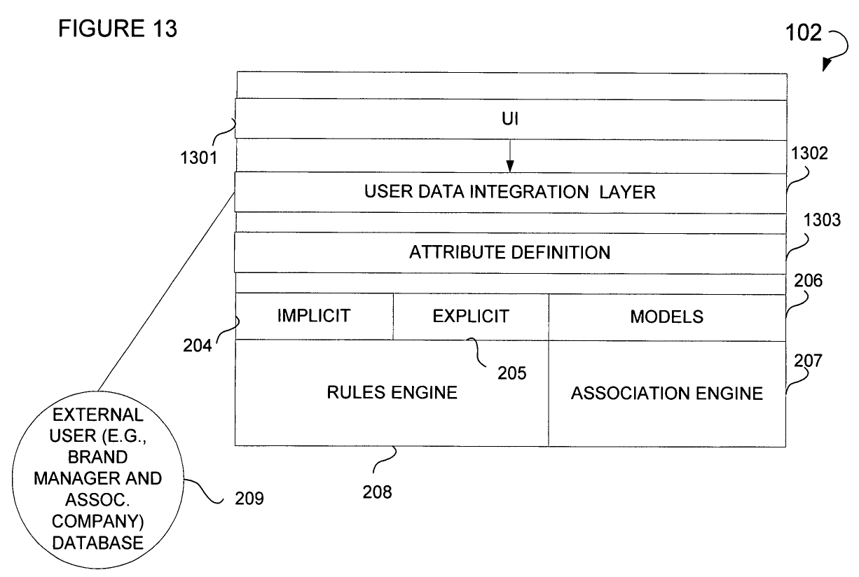

FIG. 13 is a block diagram depicting various modules that make up the module 102. Illustrated is a user interface 1301 that is operatively coupled to a user data integration layer 1302 or module. This module 1302 is operatively coupled to a module 1303 referenced as an attribute definition module or layer. The various functionalities associated with these various modules (e.g., 1301, 1302, and 1303) will be more fully described below.

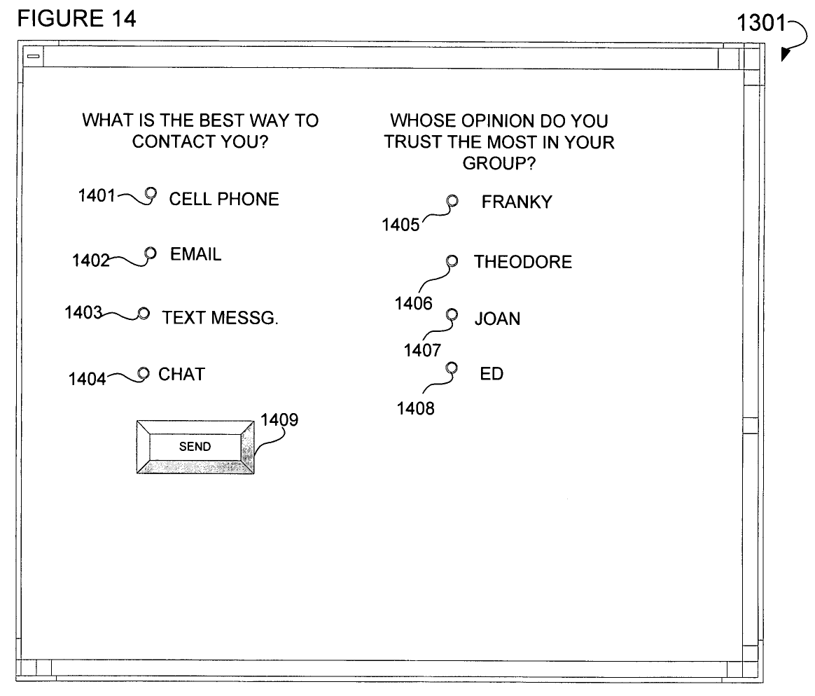

FIG. 14 is an illustration of a user interface 1301. Described are various radio buttons used to obtain follow up information from a customer such as customer 401. Radio buttons 1401-1404 allow a customer to select a preferred method of communication (e.g., email, cell phone, or text message). Radio buttons 1405-1408 allow a customer to select who they believe has the most trust worthy opinion in their immediate group or social network. Such a question may, for example, facilitate the identification of a hub. Also shown is a button 1409 to send a selection.

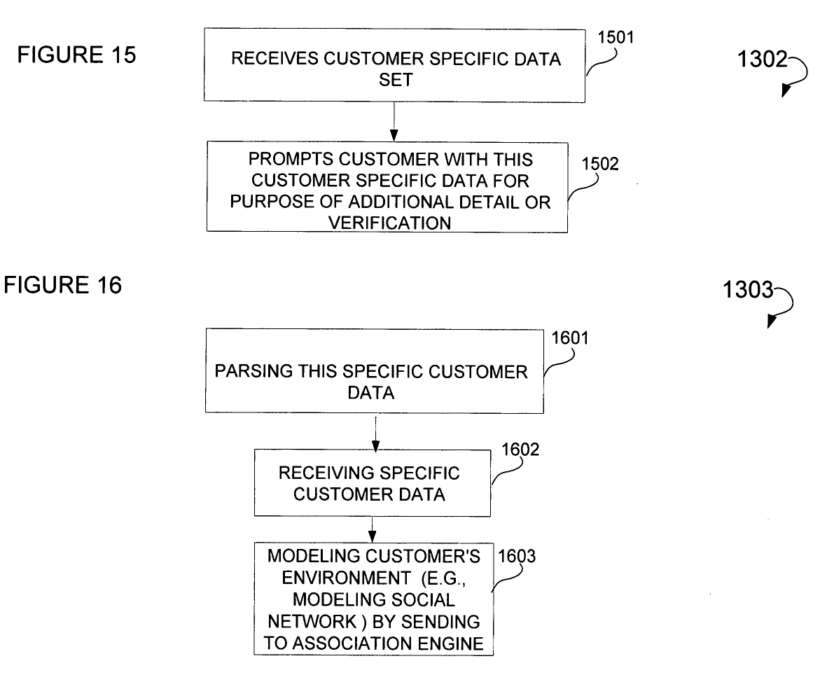

FIG. 15 is a flowchart illustrating an example method used to implement module 1302. Described is a module 1501 that receives a customer specific data set. Once this customer specific data set is received, a module 1502 is executed that prompts a customer with his customer specific data for the purpose of additional detail or verification. For example, a customer 401 is asked detailed questions regarding his or her personal likes or dislikes, for example, they may be asked whether or not they have a preference to communicate via email, cell phone, or what their actual preference of for communication may be. They may also be asked certain information relating to their age, and other information that will provide some type of demographic details regarding the customer 401. This specific data will be used to supplement data that already resides on, for example, the database 305 or 308 relating to, for example, the customer 401. This data that already may reside on one of the databases includes, for example, personal identification information such as name and contact information.

FIG. 16 is a flowchart describing an example method used to implement module 1303. Illustrated is a module 1601 that parses certain customer specific data. Once this data is parsed, a module 1602 is implemented that receives customer specific data. Once this parsed customer data is received, then a module 1603 is executed that models certain customers' environments. This modelling is accomplished via an association engine which will be more fully described below.

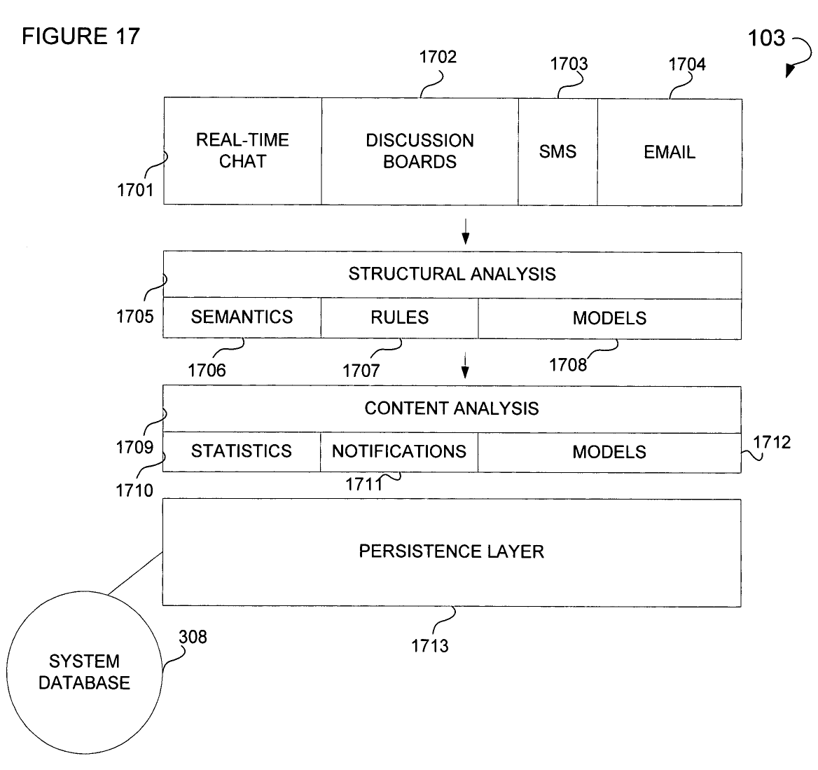

FIG. 17 is a block diagram describing the various example modules that are used to make up a module 103. Illustrated is a real time chat module 1701, a discussion board module 1702, a SMS module 1703 and an email module 1704. One or more of these various modules (e.g., 1701, 1702, 1703 or 1704) may be used to query, for example, a customer 401. These queries may be based upon certain rules provided by, for example a brand manager 301. These queries may include the use of certain slang terms such as, for example, “off the hook” that would be commonly used by the customer 401 these certain slang terms will be used in the course of asking, for example, the customer 401 regarding their thoughts and impressions as to particular goods and services. Additionally depicted in FIG. 17 is a structural analysis module 1705 this module 1705 is operatively coupled to a module 1706 titled semantics and module 1707 titled rules and module 1708 titled models. These various modules (e.g., 1705, 1706, 1707 and 1708) are operatively coupled to a content analysis module 1709 that, in turn, contains various sub modules including a statistic module 1710 and notification module 1711 and a models module 1712. Additionally, this content analysis module 1709 and various sub modules is operatively coupled to a persistence data layer 1713. This persistence data layer allows for inner operability between the above described modules (e.g., 1705-1710). This persistence 1713 allows for these various modules to couple and communicated with, for example, a system database 308 or additionally a database 305. The functionality associated with these various modules depicted in FIG. 17 will be more fully described and depicted below.

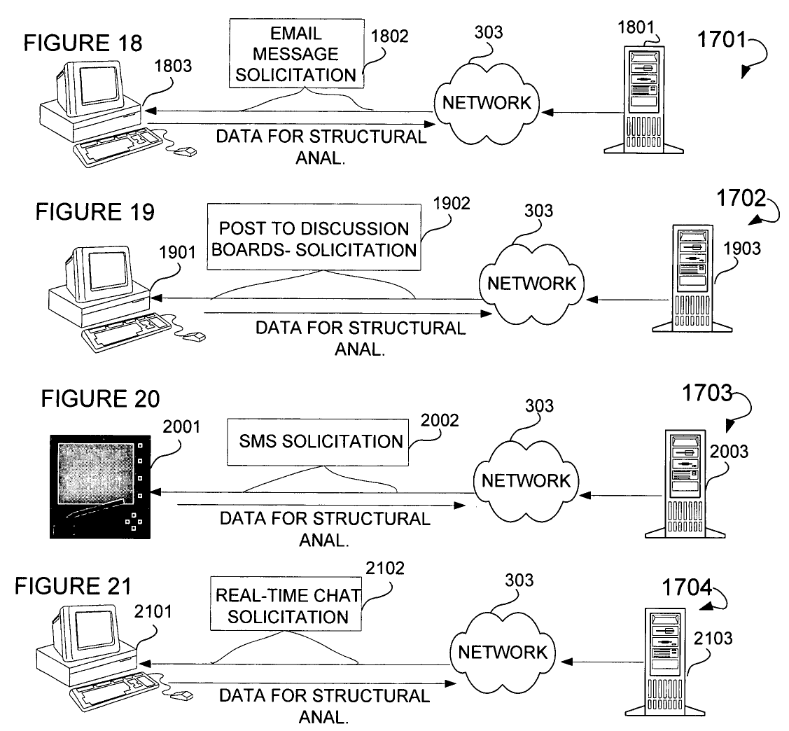

FIG. 18 is a system diagram describing module 1701. Illustrated is an email server 1801 operatively coupled to a network 303. This network 303 is, in turn, operatively coupled to a computer system 1803. In some embodiments, the computer system 1803 receives an email message solicitation 1802 from the email server 1801. This email solicitation may contain certain questions or interrogative statements directed towards a user such as, for example, customer 401 that is utilizing the computer system 1803. In response to the email message solicitation 1801, data is provided for structural analysis to, for example, a server system 304.

FIG. 19 is a system diagram depicting an example system used to direct questions or interrogative statements to, for example, customer 401 as implement via a module 1702. Described is a message server 1903 wherein messages and questions regarding, for example, a good or service are posted by the customer 401. Utilizing a computer system 1901, a customer 401 may access these questions across a network 303. These questions may, for example, may be a post to a discussion board or a solicitation to post on discussion board as described in solicitation 1902. Once this solicitation to post is provided to the customer 401 via the computer system 1901, this customer 401 may provide data for structural analysis via the computer system 1901 across the network 303 to, for example, the system server 304.

FIG. 20 is a system diagram describing a system used to implement module 1703. Described is a simple mail service 2003 that may send SMS messages across a Transmission Control Protocol/Internet Protocol (TCP/IP) network, a Global System for Mobile Communications (GSM) network, or, for example, a Code Divisional Multiple Access (CDMA) network. Network 303 may be any one of these previously mentioned networks. This SMS solicitation may be in the form of, for example, solicitation 2002 that is sent across the network 303 to a Personal Digital Assistant (PDA) 2001. Once received at the PDA 2001, this solicitation containing, for example, an interrogative statements or questions regarding goods or services may be answered by, for example, a customer 401 who will, in turn, provide data across via the PDA 2001 across the network 303 to, for example, a system server 304 wherein these response are recorded.

FIG. 21 is a system diagram describing a system used to implement module 1704. Described is real time chat system wherein a real time chat server 2103 is utilized by, for example, a brand manager 301 to ask questions of a customer 401. These questions, as provided by real time chat solicitation 2102, are sent across the network 303 to a computer system 2101 wherein the customer 401 answers questions and provides data back across the network 303 via the computer system 2101 and back across the network 303 to the chat server 2103. This chat service 2103, is operatively coupled to the system server 304, or some other suitable server, that allows for the brand manager 301 to communicate with the customer 401.

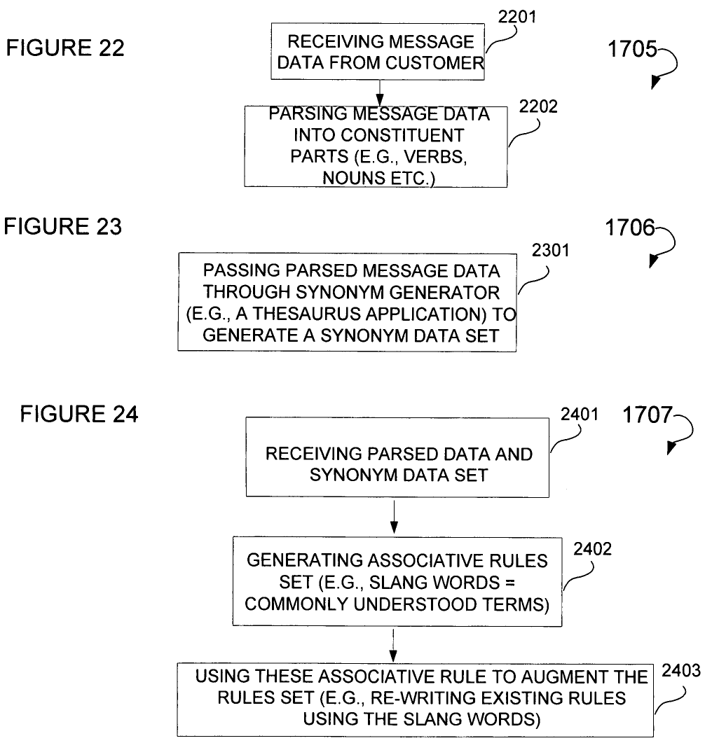

FIG. 22 is a flow chart illustrating an example method used to implement module 1705. Described is a module 2201 that receives data from a customer such as customer 401. Once the data is received from the customer, a module 2202 is executed that parses message data into constituent parts, for example, verbs, nouns other types of structures used in the underlying language in the formal structure of, for example, sentences.

FIG. 23 is a module that supports module 1706. Illustrated is a module 2301 that passes parsed message data through a synonym generator, such as a thesaurus application. The parsed message data may then be associated with certain synonyms. This process may be more fully described below.

FIG. 24 is a flowchart used to illustrate an example method to implement a module 1707. Illustrated is a module 2401 that receives a parsed data and synonym set. Once received, a module 2402 is executed that generates an associated rule set. For example, a rule is created whereby the word “cool” may be understood to mean “good”, the word “aight” to be understood to mean “all right” or, for example, the word “benjamin” understood to mean “money”. Once the associative rule set is generated, a module 2403 is executed wherein these associative rules are used to augment an existing rule set such that the slang words are incorporated and may replace certain synonyms. Replacement of certain words for their slang synonyms may occur where a certain customer commonly uses the slang synonym, in lieu of, the more traditional word. For example, if a customer commonly refers to money as “bejamins, then this word may be used to money when asking the customer questions. The sentence “Does it cost a lot of money?” may be rewritten as “Does it cost a lot of benjamins?”.

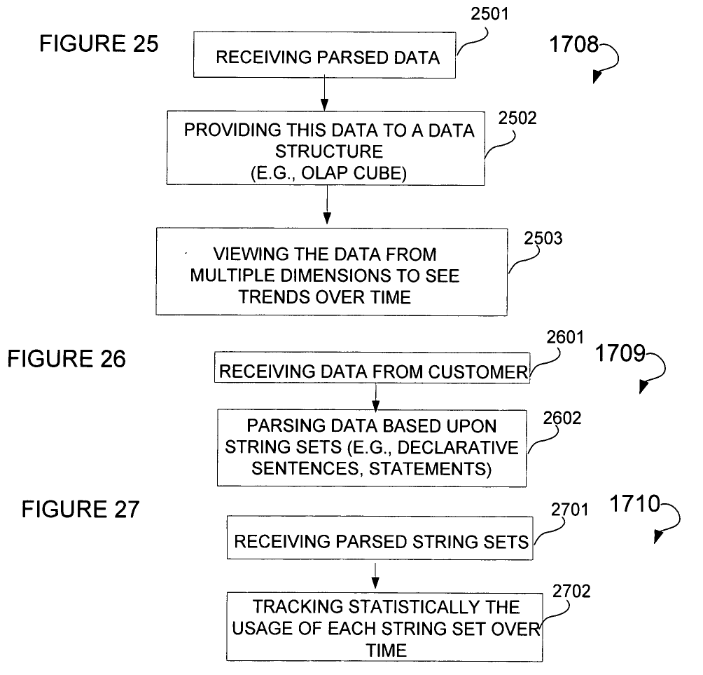

FIG. 25 is a flowchart illustrating an example method used to implement a module 1708. Described is a module 2501 that receives parsed data. Once received, a module 2502 is implemented that provides this data to a data structure, for example, a multidimensional cube of an OLAP database such as database 308. Once this data is provided, a module 2503 is implemented that allows, for example, a brand manager 301 to view this data for multiple dimensions to see trends over time.

FIG. 26 is a flowchart illustrating an example method used to implement a module 1709. Described is a module 2601 that receives data from a customer, for example, customer 401. Once received, the module 2602 is executed that parses statements into a database based upon certain string sets. For example, the declarative statement “that ride is off the hook!” may be parsed into phrases: “that ride” and “off the hook”.

FIG. 27 is a flowchart describing an example method to implement a module 1710 is illustrated. In some cases, a module 2701 parses a string set into is constituent parts. Once parsed, a module 2702 is executed that tracks statistically the usage of each string set over time. For example, if a customer 401 uses the phrase “off the hook” or the term “ride” over a certain period of time, then every instance of this usage is tracked utilizing the module 2702.

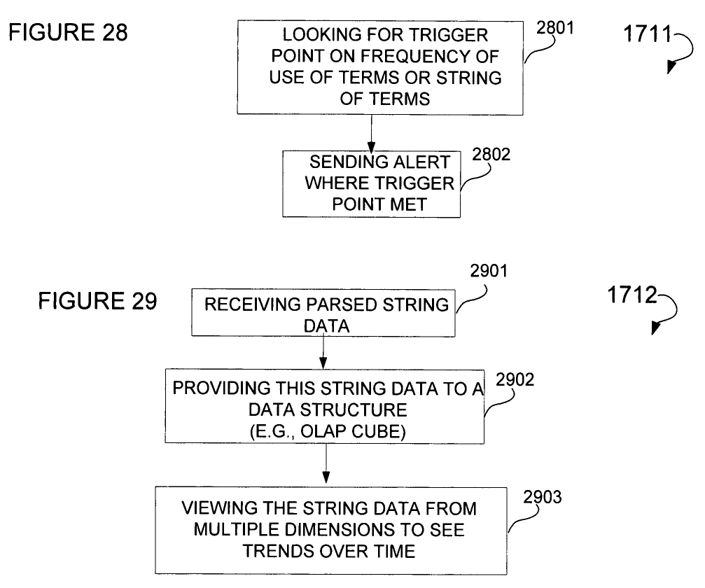

FIG. 28 is a flowchart illustrating an example method used to implement a module 1711. Illustrated is a module 2801 that looks for a trigger point with regard to the frequency of the use of a string or term. Once this trigger is activated, then a module 2802 is implement that sends an alert where this trigger point is met. For example, a brand manager 301 or system administrator may set a trigger point of a certain number of uses of a phrase over a period of time. Once this trigger point is met, then an alert may be sent to, for example, the brand manager 301 to inform them that a particular phrase in the form of string or particular term has become statistically significant enough to be incorporated into the rule set for future in use in interrogative statements or questions directed at, for example, the customer 401.

FIG. 29 is flowchart illustrating an example method to implement a module 1712. Described is a module 2901 that receives a parsed string data. Once this parsed string data is received, a module 2902 is implemented that provides this string data to a data structure such as, for example, an OLAP multidimensional cube. Once provided to the data structure, a module 2903 is executed that allows a individual such as the brand manager 291 to view this string data from a variety of dimensions such that trends can be seen by this brand manager 301. These trends may relate to, for example, the usage of the string data by a customer 401.

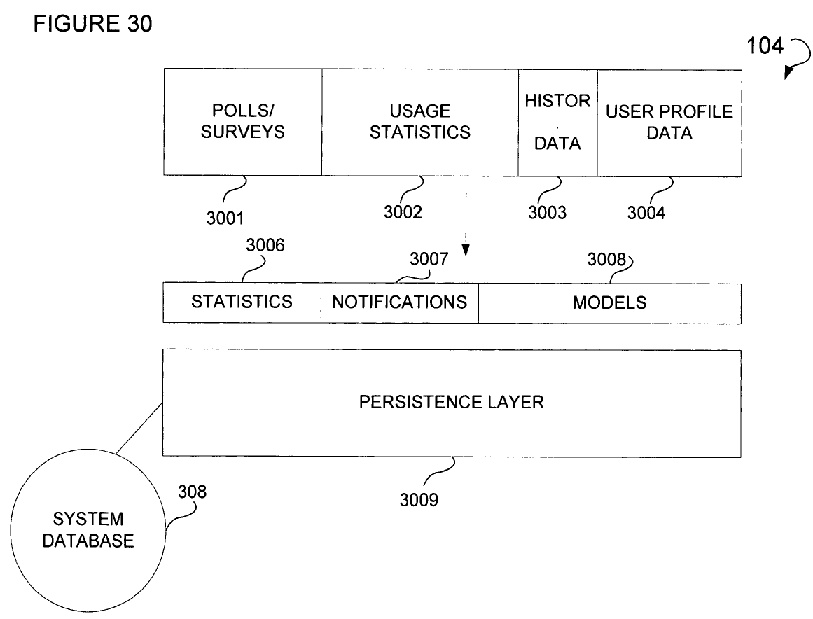

FIG. 30 is a block diagram describing various example modules used to implement the module 104. Described is a survey module 3001, a use statistic module 3002, a historical data module 3003, and a user profile data module 3004. In some embodiments, these various modules (e.g., Nos. 3001-3004) may be used to glean information relating to a customer 401's interest in a particular good or service. These various modules (e.g., Nos. 3001-3004) are operatively coupled to various other modules. For example, a statistics module 3006 provides statistical information with regard to these various previously described modules (e.g., Nos. 3001-3004). This statistical information may track, for example, the usage by a customer 401 of a particular good or service in their conversation with, for example, a brand manager 301. Additionally, a notification module 3007 is implemented that allows for notification where certain usages of a particular word or phrase are deemed adequate to be used to generate an additional rule set. Also described is a module 3008. These various modules (e.g., Nos. 3006-3008) will be more fully described below. Additionally described is a persistence layer 3009 that is used to interface with, for example, a database 308 or 305.

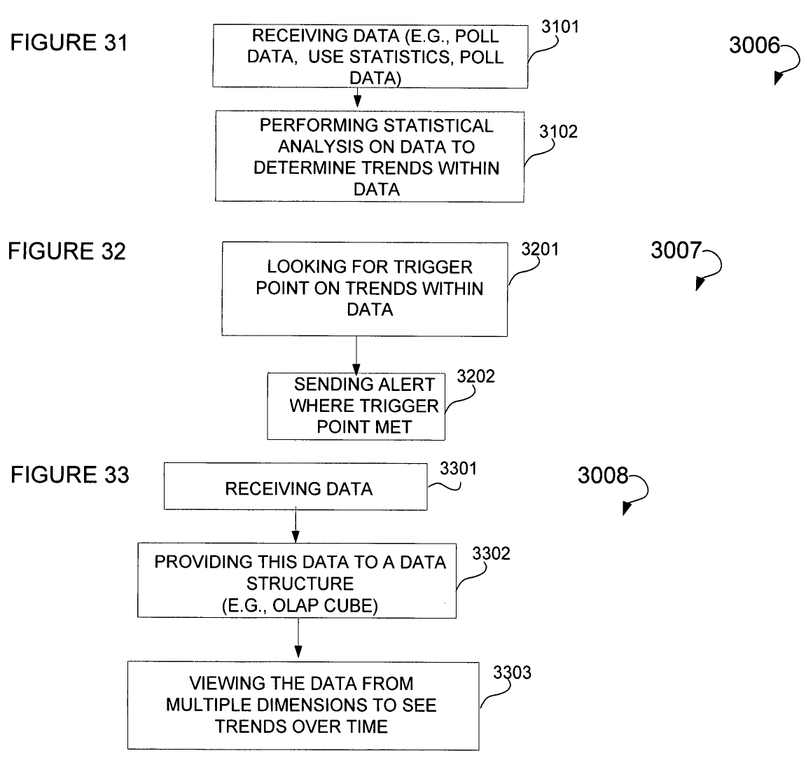

FIG. 31 is a flowchart used to illustrate an example method to implement module 3006. Described is a module 3101 that receives data in the form of, for example, poll data, statistics or related information. Once received, a module 3102 is implemented that performs statistical analysis on this data. In some embodiments, trends are highlighted relating to the usage of particular words or phrases during the course of discourse regarding goods or services that, for example, the customer 401 may be interested in. These statistical methods include descriptive statistics, inferential statistics, or other types of statistical methods such as, for example, predictive analytics, regression analytics or other such suitable statistical methods.

FIG. 32 is a flowchart depicting an example method used to implement a module 3007. Described is a module 3201 that looks for a triggering point or trends within data. This triggering point may be established by, for example, a brand manager 308 or system administrator. Once this trigger point is set, and more importantly once this trigger point is actually triggered, a module 3202 is implement that sends an alert where the trigger is met. This trigger may be in relationship to the usage of words or phrases by one or more customers such as customer 401 during the course of conducting discourse regarding a particular good or service.

FIG. 33 is a flowchart used to depict an example method to implement a module 3008. Described is a receiving data module 3301 that receives data. Once received, a module 3302 is implement that provides this data to a data structure. This data structure may be an OLAP multidimensional cube. Once provided to the data structure, a module 3303 may be implemented that allows for the viewing of data over multiple dimensions to see trends over time.

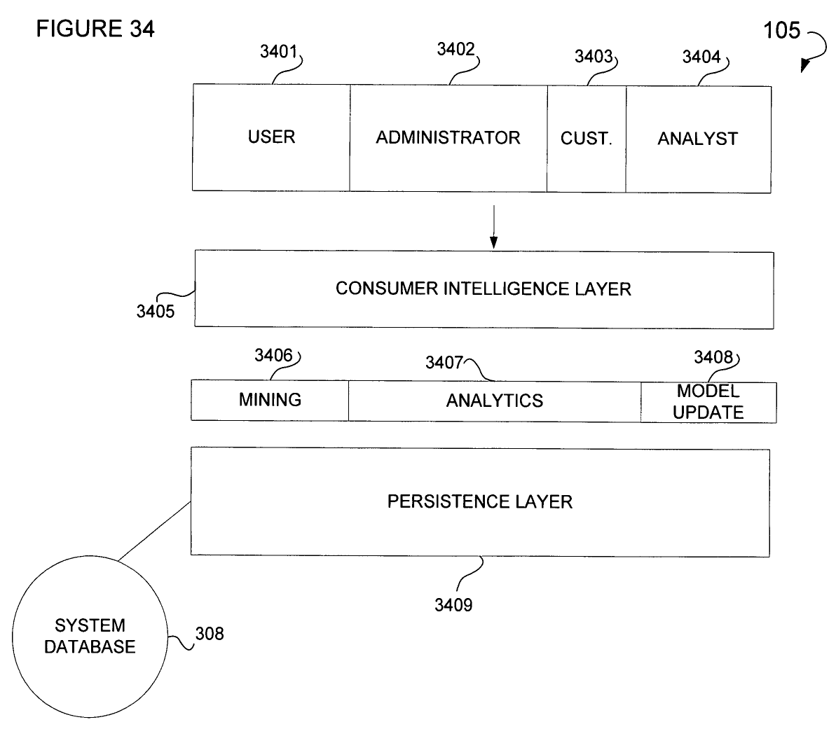

FIG. 34 is a block diagram describing various modules used to make up a module 105. Illustrated are a user module 3401, an administrative module 3402, a customer module 3403 and an analyst module 3404. These various modules (e.g., Nos. 3401-3404) represent individuals with certain privileges that enable them to, for example, access the system server 304. One or more of these individuals may interact with a module 3405 (e.g., a consumer intelligence layer or module). The functionality of this module 3405 is described more fully below, but this module contains certain sub modules such as a sub module 3406 for data mining, an analytics sub module 3407, and an update module 3408 for updating models. Also described is a persistence layer 3409 that allows for interaction between the module 3405 and its various sub modules and, for example, database 305 or 308. The various functionalities associated with these various modules or sub modules will be more fully described below.

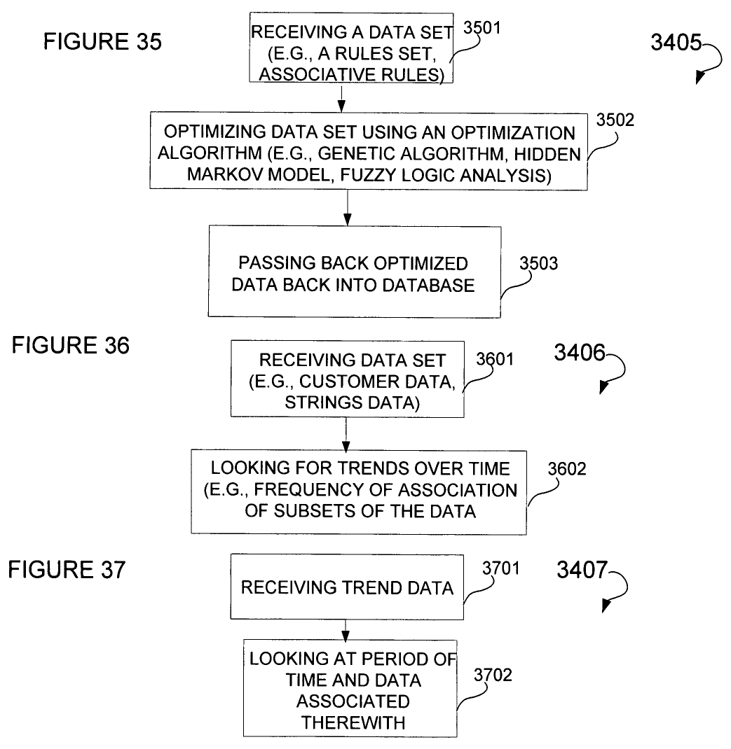

FIG. 35 is a flowchart illustrating an example method used to implement a module 3405. Illustrated is a module 3501 that receives a data set, for example, a rules data set or associated rules. Once received, the module 3502 is implemented that optimizes this data set using an optimization algorithm. The optimization algorithms may include, for example, a genetic algorithm, a Hidden Markov model, a fuzzy logic analysis or some other suitable type of optimization algorithm involving artificial intelligence that is well known in the art. For example, some type of stochastic algorithm may be implemented such as a genetic algorithm. In embodiments where genetic algorithms are implemented, certain a rule set is selected. This selection may be random or based upon certain groups of associated rules (e.g., rules may be associated based upon their usage by a group of customers). Once selected, these rules may be combined together based upon factors including, for example, how common each rule is used. This combination of certain rules may occur through a number or iterations (e.g., 500 iterations) before a final, optimized new rule set is created. Once combined, then a new, optimized rules set is generated for use in, for example, a question set for a customer such as customer 401. As with biological systems, a certain level of elitism may exist such that certain rules may not be allow to be replaced due to the frequency with which these rules are used. For example, the word “cool” may never be replaced due to the commonness with which it is used. Once optimized a module 3503 is implemented that passes the optimized data back into a database as previously described as database may be 305 or 308 amongst others. Once passed back, the module 1303 attribute definition module may use the new words for posing questions to a customer.

Other types of stochastic algorithms may also be implemented. For example, in one embodiment, a Simulated Annealing (SA) algorithm may also be implemented, wherein various synonyms are used to gradually replace a word or phrase and then implemented in a question set for a customer. Specifically, in one case, the most closely related words to a target word are randomly chosen to replace the target word, hence making a new target word to be used in a question set. Once replaced, then the closest word to the new target word is used to replace the new target as a second new target, and the target word and second new target compared to determine whether they are synonyms. Where they are synonyms, then the process may continue. Where they are not synonyms, then the process will end (e.g., a termination case). This process of replacement may continue for forever until the termination case is met, or for some predefined number of iterations set by a system administrator or other suitable person. For example, the word “benjamin” may be replaced with the new target word “cash”, and cash may be replaced with the second new target “money” but, “good” a synonym of “money”, may not be used to replace “benjamin”. At this point, a termination case may occur. Once optimized a module 3603 is implemented that passes the optimized data back into a database as previously described as database may be 305 or 308 amongst others. Once passed back, the module 1303 attribute definition module may use the new words for posing questions to a customer. In some cases, the genetic algorithm will be optimized by the SA algorithm or some other suitable algorithm. Further, in some cases, another non-AI type algorithm will be utilized.

FIG. 36 is a flow chart describing an example method used to implement a module 3406. Illustrated is a module 3601 that receives a data set. Once the data set is received, a module 3602 is implemented that looks for trends over time based upon, for example, the frequency of association of subsets of data. For example, where there is a constant association between particular words and phrases as used by a customer, for example, customer 401 to describe a good or service a trend may exist (e.g., the use of “red” and “HUMMER™”). The definition of trend may be based upon certain arguments or parameters or definitions provided by, for example, a system administrator or a brand manager 301.

FIG. 37 is a flowchart illustrating an example method to implement a module 3407. Described is a module 3701 that receives trend data. Once received, a module 3702 is implemented that looks at a period of time associated with a particular piece of data. In some embodiments, by looking at a period of time associated with a period of data some type of statistical analysis can be generated or understood with respect to the data. This trend can then be analyzed for the purposes of understanding certain points within the data, for example, where there are peaks, valleys, or other relevant information regarding the data out wires and the like.

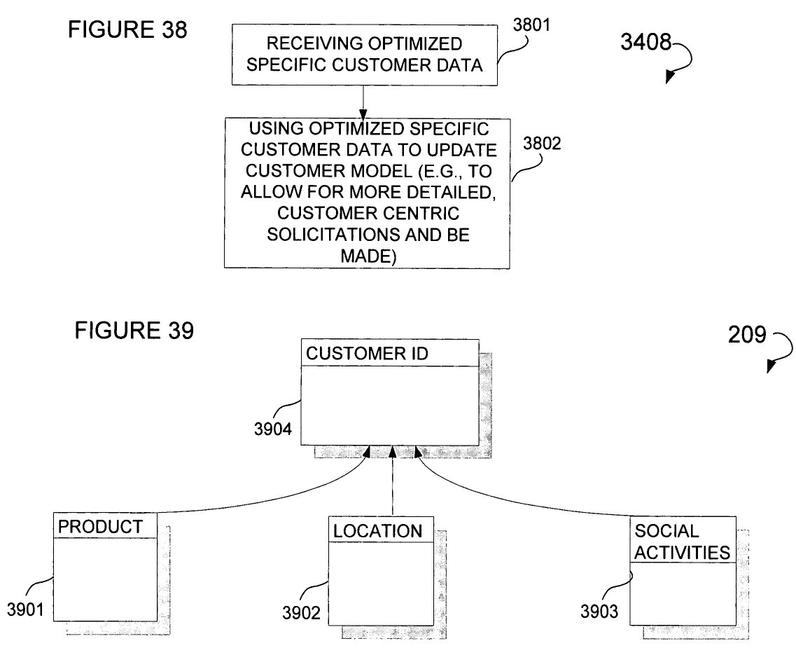

FIG. 38 is a flowchart used to illustrate an example method used to implement a module 3508. Illustrated is a module 3801 that receives optimized specific customer data. Once this optimized specific customer data is received, a module 3802 is implemented or executed that uses the optimized specific customer data to update a customer model. Through this updating of the customer model, more customer centric solicitations can be made to, for example, a customer 304. For example, if during the course of a brand manager 401 discoursing via one of the previous described methods or means with the customer 401 it becomes apparent that customer 401 begins using a new term or phrase to describe their feelings, intuitions, or views towards a particular good or service, this new word or phrase must be added to represent data to that particular customer model. If, for example, a customer 401 begins to use the word “wicked” in describing a particular good or service, then this term must be added to the model that is associated with the particular customer such as, for example, 401. By adding this word, future conversations that a brand manager 301 may have with customer 401 may include the use of the word “wicked”.

### Storage Level

Some embodiments may include a storage level that is implemented whereby tables of data are created, and data is inserted into, and/or selected from, these tables using SQL or some other database-query language known in the art. In some other embodiments, the storage level may contain a number of multi-dimensional cubes or hyper cubes, containing multidimensional data from which data is selected from or inserted into using a Multidimensional Expression (MDX) language. In this the case of a database using tables and SQL a database application such as, for example, MYSQL™, SQLSERVER™, Oracle 81™ or 10G™, or some other suitable database application may be used to manage the data. In this the case of a database using cubes and MDX a database type such as a Multidimensional On Line Analytic Processing (MOLAP), Relational On Line Analytic Processing (ROLAP), and a Hybrid Online Analytic Processing (HOLAP), or some other suitable database application may be used to manage the data. These tables or cubes made up of tables, in the case of ROLAP are organized into an RDS or Object-Relational-Database Schemas (ORDS), as is known in the art. These schemas can be normalized using certain normalization algorithms so as to avoid abnormalities such as non-additive joins and other problems. Additionally, these normalization algorithms include Boyce-Codd Normal Form or some other normalization, optimization algorithm known in the art.

FIG. 39 is an example Relational Data Schema (RDS) that may reside on, for example, a database 209 illustrated is a table 3904 titled customer ID information. This customer ID information table may include tuples relating to, for example, the name of a customer, their physical address, their social security number or other information that may uniquely identify the customer. This table 3904, and at least some of the data that is contained within it, can serve as a constraint for the entire relational schema. Also illustrated is a table 3901 titled “product” that contains various products that may be associated with a particular customer. These products include both goods and services. Also described is a table 3902 titled “location” that may contain the location of a particular customer. Additionally described is a table 3903 titled “social activities” that may describe various social activities that a particular customer in table 3904 may be involved with or associated with. The various tuples that are used to fill up these various tables (e.g., Nos. 3901-3904) may include, for example, string, integers, Character Large Objects (CLOB) or some other suitable data type. This example RDS may reside not only on a database 209 but may also reside on, for example, a database 305 or database 308.

### Component Design

Some example embodiments may include the above described three tiers or levels being written as one or more software modules with each module contributing to the functionality of each level or tier. Common too many of these modules are the ability to generate, use and manipulate the above described data and data sets. These modules, and associated functionality, may be used by the client, server, or peer applications. These various modules can be implemented into the system on an as-needed basis. These modules may be written in an object-oriented-computer language such that a component oriented or object-oriented programming technique can be implemented using a Visual Component Library (VCL), Component Library for Cross Platform (CLX), Java Beans (JB), Java Enterprise Beans (EJB), Component Object Model (COM), or Distributed Component Object Model (DCOM) or other suitable technique. These modules are linked to other modules via various APIs and then compiled into one complete server and/or client application. The process for using modules in the building of client and server applications is well known in the art. Further, these modules, and the tiers that they make up, are linked together via various distributed programming protocols as distributed computing modules.

### Distributed Computing Modules

Some example embodiments may include remote procedure calls being used to implement one or more of the above described levels of the three-tier architecture across a distributed programming environment. For example, a logic level resides on a first computer system that is remotely located from a second computer system containing an Interface or storage level. These first and second computer systems can be configured in a server-client, peer-to-peer or some other configuration. These various levels can be written using the above described component design principles and can be written in the same programming language, or a different programming language. Various protocols are implemented to enable these various levels, and components contained therein, to communicate regardless of the programming language used to write these components. For example, a module written in C++ using the Common Object Request Broker Architecture (CORBA) or Simple Object Access Protocol (SOAP) can communicate with another remote module written in Java. These protocols include SOAP, CORBA, or some other suitable protocol. These protocols are well-known in the art.

### A System of Transmission Between a Server and Client

In some embodiments, the above described components that make up the platform architecture communicate using the Open Systems Interconnection Basic Reference Model (OSI) or the Transmission Control Protocol/Internet Protocol (TCP/IP) protocol stack models for defining network protocols that facilitate the transmission of data. Applying these models, a system of data transmission between a server and client computer system can be described as a series of roughly five layers comprising as a: physical layer, data link layer, network layer, transport layer and application layer. Some example embodiments may include the various levels (e.g., the Interface, Logic and storage levels) residing on the application layer of the TCP/IP protocol stack. The present application may utilize HTTP to transmit content between the server and client applications, whereas in other embodiments another protocol known in the art is utilized. Content from an application residing at the application layer is loaded into the data load field of a TCP segment residing at the transport layer. This TCP segment also contains port information for a recipient application or a module residing remotely. This TCP segment is loaded into the data field of an IP datagram residing at the network layer. Next, this IP datagram is loaded into a frame residing at the data link layer. This frame is then encoded at the physical layer and the content transmitted over a network such as an internet, Local Area Network (LAN) or Wide Area Network (WAN). The term internet refers to a network of networks. Such networks may use a variety of protocols for exchange of information, such as TCP/IP etc., and may be used within a variety of topologies or structures. This network may include a Code Sensing Multiple Access Network (CSMA) such as an Ethernet based network. This network may include a CDMA network or some other suitable network.

### Marketplace Applications

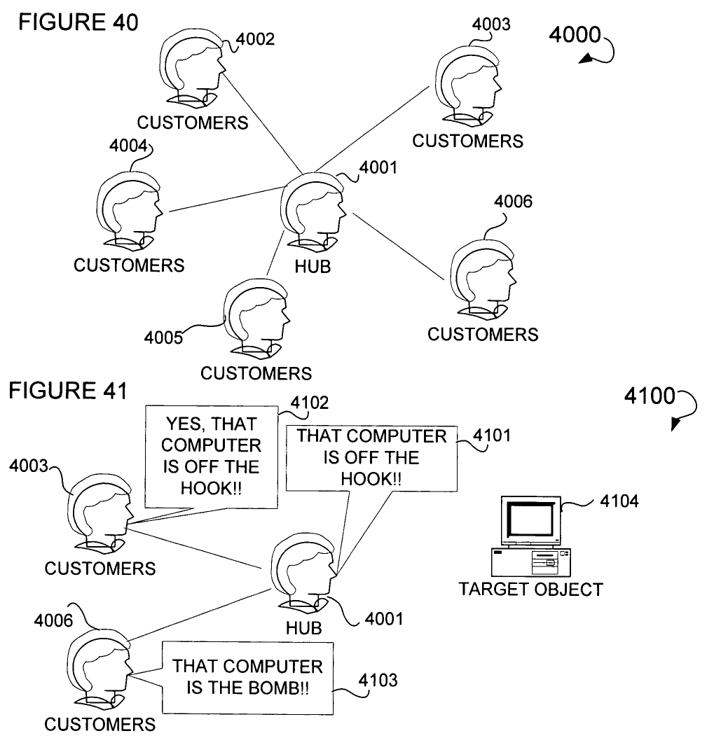

FIG. 40 is an example social network diagram 4000. Illustrated is a hub node 4001 with various edges connecting this hub node 4001 to customer nodes Nos. 4002, 4003, 4004, 4005 and 4006. In some embodiments, this network 4000 may be thought of a social network, wherein the hub and customers are individuals with certain social relationships or interactions. These social relationships or interactions are such that words, values and meanings only exist within the context of this social network. For example, the word “wicked” or the phrase “off the hook” may only have particular meaning within the context of this social network and within the context by which these various customers (e.g., Nos. 4002-4006), and the hub 4001, may use these terms and words.

FIG. 41 is a block diagram describing certain customers and hub reactions to a particular good or service. Illustrated is a target object 4104. In response to the customers 403 and 406 and the hub 4001 observing this target object 4104, certain reactions are elicited. These reactions include, for example, the reaction 4101 that “that computer is off the hook”, the reaction 4102 that “yes that computer is of the hook”, and the reaction 4103 that “that computer is the bomb.” Hub 4001, in some embodiments, may set the tone for the usage of certain words or phrases by other members of the social network, hence, the title hub. As depicted in FIG. 41, customers 403 may agree with hub 4001 and, in fact, parrot back the phrase “off the hook” in describing the target object 4104.

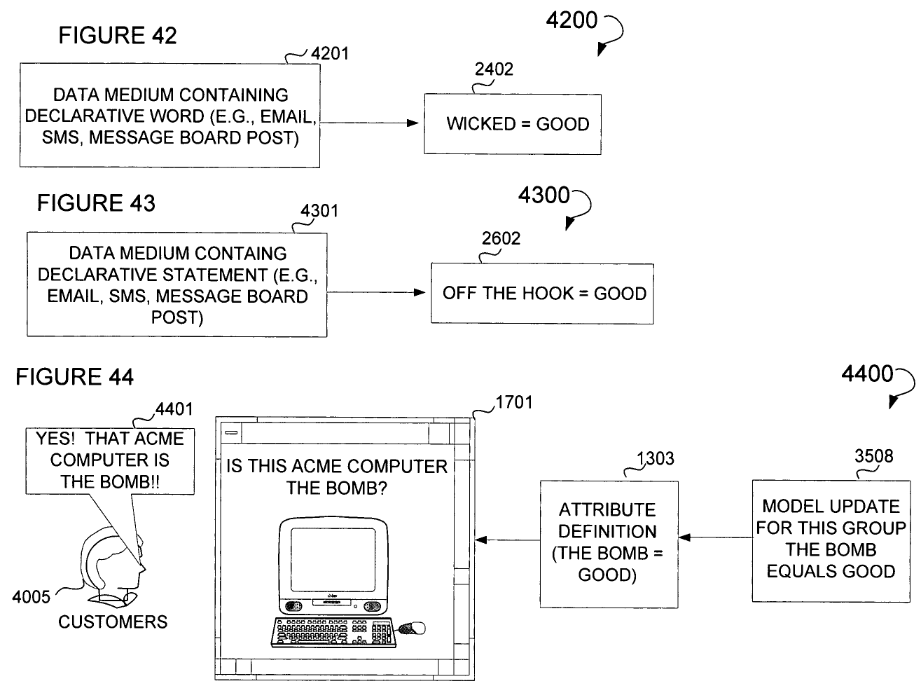

FIG. 42 is a block diagram depicting an example use 4200 of a slang word. Described is a module 4201 that is a data medium containing a declarative word. This data medium can, for example, be an email, a SMS message, message, bulletin board post, or some other medium. Once this medium, and more specifically the data contained in this medium, is provided to a module 2502, then a synonym association is generated. Here the word “wicked” is associated with the word “good”.

FIG. 43 is a block diagram describing an example use 4300 of a phrase. Described is a data medium 4301 containing a declarative statement. This declarative statement is then passed to a module 2702, wherein the phrase “off the hook” is determined to be synonymous with the word “good”.

FIG. 44 is a block diagram illustrating an example customer reaction 4400. Described is a customer 4005 who, upon viewing a good or service and being asked a question about that good or service, reacts. More to the point, the customer 4005 reaction to the question “is this acme computer the bomb?” as displayed in UI 1701 their reaction is that “yes this acme computer is the bomb?” as described in dialog box 4401. This display, and interrogative question, is provided by UI 1701 as the results of the execution of the module 3508 that seeks to update a group and model for communicating with a particular customer such as customer 4005. This updated model is then passed to the attribute definition module 1303, wherein a question with the new word or phrase is posed to a customer.

In some embodiments, a system includes a receiver residing on a server to receive a rules set, a generator residing on a server to generate a rules model, a transmitter residing on a server to transmit a solicitation of data from a customer regarding good and services, and a second generator to create an updated rules model using an AI algorithm, wherein the AI algorithm is a stochastic algorithm. Moreover, the system further comprises the receiver to receive the rules set from a brand manager. Additionally, the system may further comprise the receiver to receive the rules set from a database. Further, a transmitter to transmit the rules model to solicit responses from a customer. In addition, the updated rules model is displayed to a customer. The system may further comprise a storer to store the updated rules model into a database, wherein the database utilizes On Line Analytic Processing (OLAP). Still further, the system may further comprise a transmitter residing on a second server to transmit data using a communication process the process selected from a group of processes consisting of discussion boards, email, real-time chat, and Short Message Service (SMS) messages.

In some example embodiments, a method includes receiving a rules set, generating a rules model, soliciting data from a customer regarding good and services, and creating an updated rules model using an AI algorithm, wherein the AI algorithm is a stochastic algorithm. Further, the method further includes receiving the rules set from a brand manager. Additionally, the method further comprising receiving the rules set from a database. Moreover, the method further includes using the rules model to solicit responses from a customer. In addition, the method further includes presenting the updated rules model to a customer. The method further including storing the updated rules model into a database, wherein the database utilizes On Line Analytic Processing (OLAP). Still further, the method further including soliciting data using a communication process the process selected from a group of processes consisting of discussion boards, email, real-time chat, and Short Message Service (SMS) messages.

Some example embodiments may include, a computer-readable medium embodying instructions, the instructions including a first instruction set to receive a rules set, a second instruction set to generate a rules model, a third instruction set to solicit data from a customer regarding good and services, and a fourth instruction set to create an updated rules model using an AI algorithm.

An apparatus including means for receiving a rules set, means for generating a rules model, means for soliciting data from a customer regarding good and services, and means for creating an updated rules model using an AI algorithm.

### A Computer System

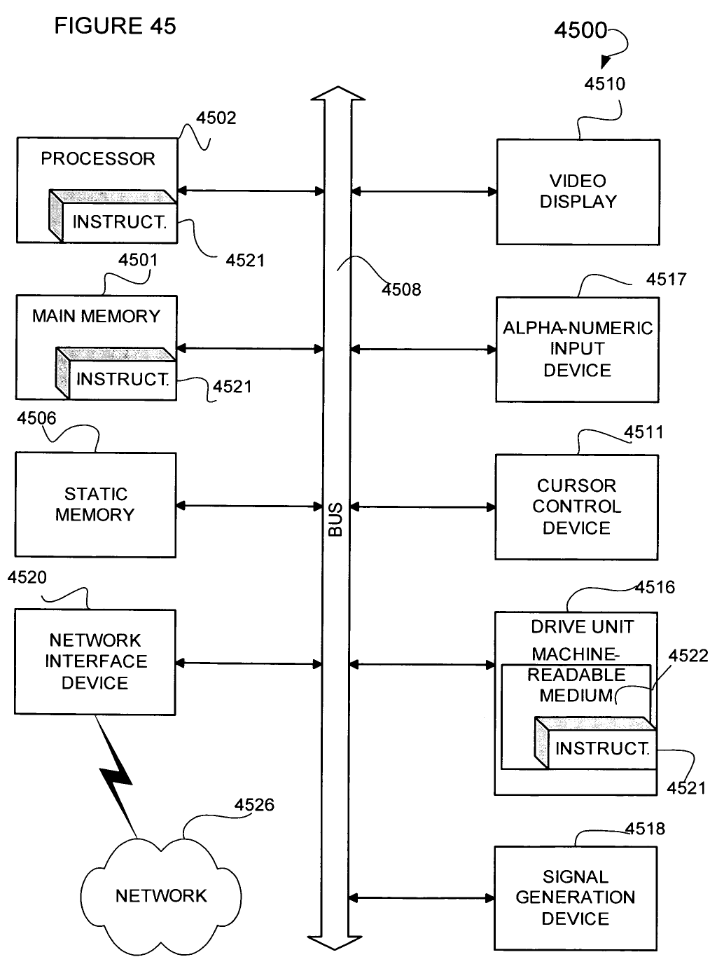

FIG. 45 shows a diagrammatic representation of a machine in the example form of a computer system 4500 within which a set of instructions for causing the machine to perform any one or more of the methodologies discussed herein may be executed. In alternative embodiments, the machine operates as a standalone device or may be connected (e.g., networked) to other machines. In a networked deployment, the machine may operate in the capacity of a server or a client machine in server-client network environment, or as a peer machine in a peer-to-peer (or distributed) network environment. The machine may be a Personal Computer (PC), a tablet PC, a Set-Top Box (STB), a Personal Digital Assistant (PDA), a cellular telephone, a web appliance, a network router, switch or bridge, or any machine capable of executing a set of instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein. Example embodiments can also be practiced in distributed system environments where local and remote computer systems which are linked (e.g., either by hardwired, wireless, or a combination of hardwired and wireless connections) through a network, both perform tasks. In a distributed system environment, program modules may be located in both local and remote memory-storage devices (see below).

The example computer system 4500 includes a processor 4502 (e.g., a Central Processing Unit (CPU), a Graphics Processing Unit (GPU) or both), a main memory 4501 and a static memory 4506, which communicate with each other via a bus 4508. The computer system 4500 may further include a video display unit 4510 (e.g., a Liquid Crystal Display (LCD) or a Cathode Ray Tube (CRT)). The computer system 4500 also includes an alphanumeric input device 4517 (e.g., a keyboard), a User Interface (UI) cursor controller 4511 (e.g., a mouse), a disc drive unit 4516, a signal generation device 4518 (e.g., a speaker) and a network interface device (e.g., a transmitter) 4520.

The disc drive unit 4516 includes a machine-readable medium 4522 on which is stored one or more sets of instructions and data structures (e.g., software) embodying or utilized by any one or more of the methodologies or functions described herein. The software may also reside, completely or at least partially, within the main memory 4501 and/or within the processor 4502 during execution thereof by the computer system 4500, the main memory 4501 and the processor 4502 also constituting machine-readable media.

The instructions 4521 may further be transmitted or received over a network 4526 via the network interface device 4520 utilizing any one of a number of well-known transfer protocols (e.g., HTTP, SIP).

While the removable physical storage medium 413 is shown in an example embodiment to be a single medium, the term “machine-readable medium” should be taken to include a single medium or multiple medium (e.g., a centralized or distributed database, and/or associated caches and servers) that store the one or more sets of instructions. The term “machine-readable medium” shall also be taken to include any medium that is capable of storing, encoding or carrying a set of instructions for execution by the machine and that cause the machine to perform any of the one or more of the methodologies described herein. The term “machine-readable medium” shall accordingly be taken to include, but not be limited to, solid-state memories, optical and magnetic medium, and carrier wave signals.

It is to be understood that the above description is intended to be illustrative, and not restrictive. Although numerous characteristics and advantages of various embodiments as described herein have been set forth in the foregoing description, together with details of the structure and function of various embodiments, many other embodiments and changes to details will be apparent to those of skill in the art upon reviewing the above description. The scope of the invention should be, therefore, determined with reference to the appended claims, along with the full scope of equivalents to which such claims are entitled. In the appended claims, the terms “including” and “in which” are used as the plain-English equivalents of the respective terms “comprising” and “wherein,” respectively. Moreover, the terms “first,” “second,” and “third,” etc., are used merely as labels, and are not intended to impose numerical requirements on their objects.

The Abstract of the Disclosure is provided to comply with 37 C.F.R. § 1.72(b), requiring an abstract that will allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in a single embodiment for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separate embodiment.

What is claimed is:

1. A system comprising:
a receiver residing on a server to receive a rules set;
a generator residing on the server to generate a rules model based upon the rules set;
a transmitter residing on the server to transmit a solicitation of data from a customer; and
a second generator residing on the server to create an updated rules model using an Artificial Intelligence (AI) algorithm.

2. The system of claim 1, further comprising the receiver to receive the rules set from a brand manager.

3. The system of claim 1, further comprising the receiver to receive the rules set from a database.

4. The system of claim 1, further comprising a second transmitter to transmit the rules model to an attribute definition model residing on the server.

5. The system of claim 1, wherein the AI algorithm is a stochastic algorithm.

6. The system of claim 1, wherein the updated rules model is displayed to a customer.

7. The system of claim 1, further comprising a storer residing on the server to store the updated rules model into a database.

8. The system of claim 7, wherein the database utilizes On Line Analytic Processing (OLAP).

9. The system of claim 1, further comprising a transmitter residing on a second server to transmit data using a communication process the process selected from a group of processes consisting of discussion boards, email, real-time chat, and Short Message Service (SMS) messages.

10. A method comprising:
receiving a rules set;
generating a rules model based upon the rules set;
soliciting data from a customer; and
creating an updated rules model using an Artificial Intelligence (AI) algorithm.

11. The method of claim 10, further comprising receiving the rules set from a brand manager.

12. The method of claim 10, further comprising receiving the rules set from a database.

13. The method of claim 10, further comprising using the rules model to solicit responses from the customer.

14. The method of claim 10, wherein the AI algorithm is a stochastic algorithm.

15. The method of claim 10, further comprising presenting the updated rules model to the customer.

16. The method of claim 10, further comprising storing the updated rules model into a database.

17. The method of claim 16, wherein the database utilizes On Line Analytic Processing (OLAP).

18. The method of claim 10, further comprising soliciting data using a communication process the process selected from a group of processes consisting of discussion boards, email, real-time chat, and Short Message Service (SMS) messages.

19. A computer-readable medium embodying instructions, the instructions comprising:
a first instruction set to receive a rules set;
a second instruction set to generate a rules model;
a third instruction set to solicit data from a customer; and
a fourth instruction set to create an updated rules model using an Artificial Intelligence (AI) algorithm.

20. An apparatus comprising:
means for receiving a rules set;
means for generating a rules model from a rules set;
means for soliciting data from a customer; and
means for creating an updated rules model using an Artificial Intelligence (AI) algorithm.
